(19) United States
(12) Patent Application Publication
(10) Pub. No.: US 2012/0040005 A1
(43) Pub. Date: Feb. 16, 2012

(54) NANOSTRUCTURED CALCIUM-SILVER PHOSPHATE COMPOSITE POWDERS, PROCESS FOR OBTAINING THE POWDERS, AND BACTERICIDAL AND FUNGICIDAL APPLICATIONS THEREOF

(75) Inventors: José Serafín Moya Corral, Madrid (ES); Marcos Díaz Muñoz, Madrid (ES); María Flora Barba Martín-Sonseca, Madrid (ES); Francisco Malpartida Romero, Soto del Real (ES); Miriam Miranda Fernández, Llanera (Asturias) (ES); Adolfo Fernández Valdés, Llanera (Asturias) (ES); Leticia Esteban Tejeda, Madrid (ES); Sonia López-Esteban, Oviedo (ES); Ramón Torrecillas San Millán, Bendones (ES)

(73) Assignee: CONSEJO SUPERIOR DE INVESTIGACIONES CIENTIFICAS, Madrid (ES)

(21) Appl. No.: 13/142,220

(22) PCT Filed: Dec. 23, 2009
(86) PCT No.: PCT/ES2009/070628

§ 371 Date: Oct. 10, 2011

(30) Foreign Application Priority Data
Dec. 24, 2008 (ES) P200803695

(51) Int. Cl. A01N 25/26; A01P 1/00; B05D 5/00; B05D 7/24; A01N 59/26; A01P 3/00; B82Y 40/00; B82Y 30/00

(52) U.S. Cl. 424/490; 424/602; 427/180; 977/773; 977/810; 977/902; 977/890; 977/892

(57) ABSTRACT

Described in example embodiments are nanocomposite powders including calcium phosphate and silver nanoparticles on the surface of the calcium phosphate. Other example embodiments, describe methods of forming nanocomposite powders comprising a) preparing a nanometric calcium phosphate by a sol-gel processing route; and b) depositing silver nanoparticles on the calcium phosphate surface. Compositions including nanocomposite powders and uses of those compositions are also described.

### CROSS REFERENCE TO RELATED APPLICATIONS AND PRIORITY CLAIM

This application is a national phase application under 35 U.S.C. §371 of PCT/ES2009/070628 filed 23 Dec. 2009 and claims priority under 35 U.S.C. §371 and §119 to Spanish Patent Application ES P200803695 filed Dec. 24, 2008. The entire disclosure of said applications are incorporated herein by reference.

### FIELD

Described herein generally are bactericidal and fungicidal applications in the surgical implants sector, public facilities (toilets and hospitals, transport, etc.), air conditioning equipment, food, dentistry, paints, clothes and packaging (food, domestic, pharmaceutical, medical devices, etc.).

### BACKGROUND

Antibacterial properties of silver in low concentrations against a broad range of pathogens including the common bacterial strains responsible for implant-associated infections, as well as their non-toxicity to mammal cells, are well known. Most biomaterials containing silver as an Antimicrobial substance include elemental or cationic forms of a metal supported both by organic and inorganic matrices. Antimicrobial activity studies have been carried out in polymers and bioglasses containing silver, but not in nanostructured calcium-silver phosphate composite materials.

In recent years, studies have been published on the obtention of hydroxyapatite (HA) compounds with Ag using ion-exchange methods (sol-gel or co-precipitation). Such routes employ the substitution of calcium for silver, obtaining calcium-deficient hydroxyapatite. The antimicrobial response to these materials is good, but two main drawbacks have been observed: i) calcium deficiency can have negative effects on the structural stability of HA nanoparticles and on the osteoconductive capacity of HA, and ii) depending on the pH, silver may be released faster than desired. These drawbacks have led to an increased interest in silver nanoparticles as an anti-bactericidal source thanks to their low solubility in aqueous media.

Biocidal activity of silver nanoparticles is influenced by particle size. Generally, the smaller the particle size, the greater the microbial activity the particles attain, but there is commonly a problem with nanoparticle agglomeration. A solution for avoiding this drawback of agglomeration is to work with the nanoparticles adhered to the surface of different substrates.

### DESCRIPTION OF EXAMPLE EMBODIMENTS

Described herein generally are nanocomposites or nanostructured powders, hereinafter referred to as the nanocomposites, formed by a calcium phosphate, having a particle size, for example, of less than about 150 nm and Ag nanoparticles adhered to its surface, less than about 50 nm in size.

In one example embodiment, the calcium phosphate is selected from the group hydroxyapatite, α-TCP, β-TCP and combinations thereof. In another example embodiment, the calcium phosphate is hydroxyapatite (HA).

In one example embodiment, a nanostructured powder is described formed from HA nanoparticles having a size less than about 140 nm. Metallic Ag nanoparticles having a particle size of less than about 50 nm (FIGS. 1 and 2) can be adhered to the surface and homogeneously dispersed. Bactericidal and fungicidal activity is achieved based on calcium phosphates as a substrate with silver nanoparticles on its surface. Likewise, in another example embodiment, an alternative, simplistic and inexpensive process for obtaining the nanostructured composite materials is described. In another example embodiment, two different methods are used (see, for example, Example 1).

One advantage provided by the present nanocomposite powders is that nanoparticle agglomeration is avoided because the nonaparticles can be being adhered to the substrate surface. A second nanocomposite powder advantage is bactericidal and fungicidal efficiency (see for example, Example 2). A third nanocomposite powder advantage is low toxicity, demonstrated by observation of this material leaching out two orders of magnitude less silver in the case of HA/Ag (<5 ppm) than in the case of Vitelinate (approximately 800-1,300 ppm). This observation implies a toxicity far below that of commercial products, very far below toxic levels (the amount of silver used is in the order of 1% by weight), and with similar effectiveness as commercially available alternatives (see for example, Example 2). Additionally, silver is released in a much slower and controlled manner when compared to materials where Ca has been substituted for Ag. This observation is revealed by the quantitative analysis of the leached silver. Therefore, given the synergistic effect of calcium and silver on bactericidal and fungicidal behaviour, the nanocomposite powders described herein can be used as universal disinfectants.

In light of the above, in one example embodiment, nanocomposite or nanostructured powders consisting of calcium phosphate having a particle size of less than 150 nm and having Ag nanoparticles less than about 50 nm in size adhered to its surface.

In one example embodiment, the nanocomposite powders include metallic silver particles comprised of between about 0.01% and about 8% by weight of silver. In another example embodiment, the percentage is about 1% by weight of silver.

Also described herein are processes for obtaining nanocomposite powders comprising: a) preparing of a nanometric calcium phosphate from a sol-gel processing route; and b) depositing silver nanoparticles on the calcium phosphate surface.

In one example embodiment, the nanometric calcium phosphate prepared in a) has been prepared by the sol-gel processing route comprising 1) preparing an aqueous solution with an amount of triethyl phosphite and calcium nitrate obtaining a Ca/P molar ratio in the final mixture, for example, 1.67 in the case of hydroxyapatite; 2) adding a phosphorus solution drop by drop to the calcium solution while agitating strongly, maintaining a controlled temperature and pH forming a colloidal suspension; 3) agitating the colloidal suspension and subsequently ageing at ambient temperature, for example for 24 hours, to form a gel; and 4) drying of the gel in a vacuum heater until fully eliminating the solvent and calcination at temperatures between about 500° C. and about 1,000° C., in one example embodiment about 550° C., to obtain a nanometric-sized and well-crystallised powder.

In another example embodiment, the deposition in b) comprises (Method 1): i) preparing an aqueous suspension with the powder obtained in a), adjusting the pH to 5 and adding an anionic surfactant at low concentration; ii) adding, in the absence of light, an aqueous solution of the silver salt precursor having a concentration of the elemental silver content between about 0.01% and about 8% by weight in the final compound, referenced to the calcium phosphate solid content, for example, 1% by weight of silver; iii) Agitating strongly the suspension, adjusting the pH to 9, in such a manner that Ag⁺, cations precipitate as oxide (Ag₂O); iv) filtering, washing with distilled water and drying the resulting powder; and v) reducing in a H₂/Ar atmosphere within a temperature range of between about 150° C. and about 500° C., in one example embodiment, about 350° C.

In another example embodiment, the deposition in b) comprises (Method 2): i) preparing an aqueous suspension with the hydroxyapatite powder obtained a) whereto an anionic surfactant at low concentration is added; ii) adjusting the pH to 7 using an aqueous NaOH 0.1 N solution; iii) applying an ultrasound probe for 1-10 minutes and completing homogenisation and disintegration in a ball mill; iv) addition drop by drop of an amount of the silver precursor solution, AgNO₃, necessary to obtain an Ag⁰ concentration in the final product between about 0.01% and about 8% by weight in the final compound, in one example embodiment, about 1% by weight of silver; v) Agitating strongly for 10 minutes; vi) reducing the silver in situ using any known reducing agent, in one example embodiment NaBH₄, which is added drop by drop to the dispersion while continuing to agitate strongly; and vii) filtering, washing with distilled water and drying in a heater at 60° C.

In an example embodiment, the nanocomposite powders described herein can be used in an elaboration of a bactericide and/or a fungicide composite which can be employed as a universal disinfectant for an application selected from the group of surgical implants, public facilities (toilets and hospitals, transport, etc.), food, dentistry, paints, clothes, packaging (food, pharmaceutical, medical devices) and combinations thereof.

### DESCRIPTION OF THE FIGURES

FIG. 1 is a micrograph obtained by Transmission Electron Microscopy, showing a homogeneous distribution of silver nanoparticles less than 20 nm in size adhered to a hydroxyapatite nanoparticle surface of a approximately 140 nm in size, obtained by means of Method 1.

FIG. 2 is a micrograph obtained by Transmission Electron Microscopy, showing a nanocomposite powder obtained by means of Method 2, where it can be observed that the Ag nanoparticles are less than 15 nm in size.

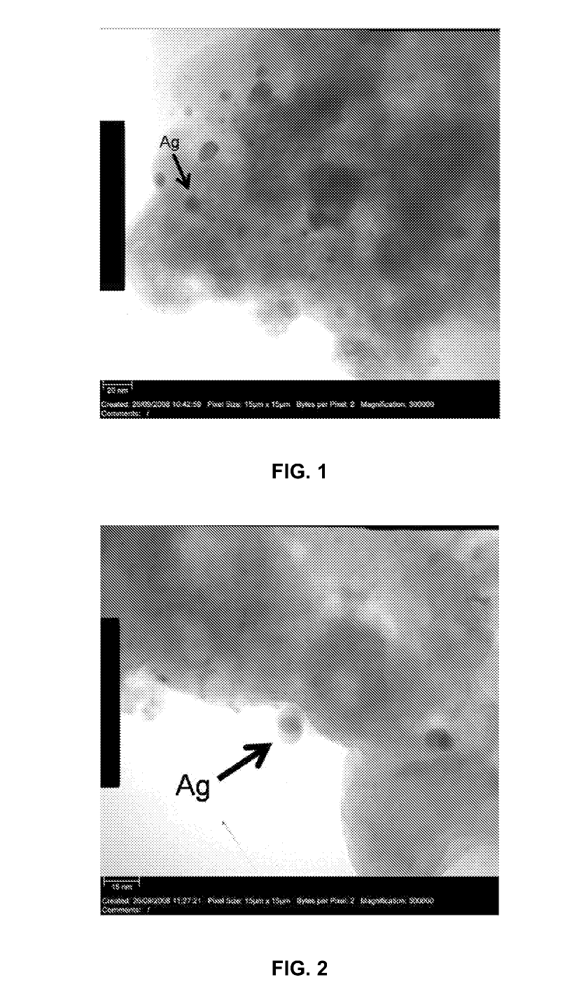

### EXAMPLE 1

### Process for Obtaining a Nanocomposite Powder

An example process for obtaining the nanocomposite powders is described. The process comprises two main preparation stages: (a) preparation of the nanometric calcium phosphate by a sol-gel processing route and (b) deposition of silver nanoparticles on the calcium phosphate surface.

### 1.1—Hydroxyapatite (HA) Synthesis as Calcium Phosphate

The precursors used for synthesizing HA were triethyl phosphite (98%, Aldrich) and calcium nitrate tetrahydrate (≧99%, Fluka). The process followed is set out in detail below:

1. The corresponding aqueous solutions are prepared using the necessary amount of these precursors to obtain a Ca/P molar ratio of 1.67 in the final mixture.
2. The triethylphosphite is added drop by drop on the calcium solution while agitating strongly, maintaining controlled temperature and pH conditions.
3. The resulting colloidal suspension is maintained with agitation and, after ageing at ambient temperature for 24 hours, forms a gel, and
4. The resulting gel is dried in a vacuum heater until fully eliminating the solvent. It is then calcinated at 550° C., obtaining a nanometric-sized and well-crystallised hydroxyapatite powder less than 150 nm in size.

### 1.2—Deposition Process of Silver on the HA Nanoparticles

At this point, the nanostructured powders were obtained by means of two different methods.

### Method 1

After HA nanoparticle synthesis by means of the sol-gel method and subsequent calcination, deposition of silver oxide as of a precursor (for example, silver nitrate) on HA dispersed in water with the optimum amount of surfactant takes place. Next, the cation Ag⁺, is reduced to Ag⁰ in an oven in an Ar/H₂ atmosphere, as explained in detail below:

a) An aqueous suspension is prepared with the hydroxyapatite powder obtained in 1.1. The pH is adjusted to 5 with agitation. In order to achieve better dispersion of the hydroxyapatite, an anionic surfactant at low concentration is introduced as a dispersing agent (1% by weight with respect to the hydroxyapatite concentration in solids),
b) An aqueous silver salt precursor solution is added, protected from light, having the necessary concentration for the elemental silver content to be comprised between 0.01% and 8% by weight in the final HA-Ag compound (referenced to the HA solid content);
c) While strongly agitating the suspension, the pH is adjusted to 9, in such a manner that Ag⁺ cations are precipitated as oxide (Ag₂O); and
d) After filtering and washing, it is dried and reduced in an Ar/10% H₂ atmosphere within the temperature range comprised between 150° C. and 500° C.

A nanocomposite powder with silver nanoparticles less than 20 nm in size, adhered to the surface of a hydroxyapatite nanoparticle approximately 140 nm in size with a homogeneous distribution, was thus obtained.

### Method 2

After HA nanoparticle synthesis by means of the sol-gel method and subsequent calcination, silver nanoparticles, Ag⁰, are deposited on hydroxyapatite as a silver precursor dispersed in water with an optimum pH and dispersing agent. The reduction is performed in situ using a reducing agent at ambient temperature.

i) An aqueous suspension is prepared with the hydroxyapatite powder obtained. In order to achieve better dispersion of the hydroxyapatite, an anionic surfactant at low concentration is introduced as a dispersing agent (Dolapix);
ii) The ph is adjusted to 7 using an aqueous NaOH 0.1 N solution in order to achieve good dispersion of the HA particles and avoid, at the same time, precipitation of Ag⁺ ions as Ag₂O, which occurs at pH values higher than 8;
iii) Ultrasound probe for 1-10 minutes. Homogenisation and disintegration in a ball mill;
iv) In order to obtain a concentration of Ag⁰ in the final product comprised between 0.01% and 8% by weight in the final HA-Ag compound, the necessary amount of precursor, AgNO₃, is added. Once added drop by drop on the HA dispersion, it is agitated strongly for 10 minutes before continuing to the next step. This process must be carried out protecting the precursor solution and the dispersion after adding the precursor from light;
v) Silver reduction is performed chemically in situ using, for example, NaBH₄ as a reducing agent, which reacts with the silver in a molar ratio of 1:8 ((NaBH₄:Ag⁺), according to the reactions:

$$\begin{matrix}8 ( {Ag}^{+} + 1 {e }^{-} ↔ {Ag}^{0} ) \\ \frac{{BH}_{4}^{-} + 3 {H}_{2} O ↔ {B ( OH )}_{3} + 7 {H}^{+} + 8 {e}^{-}}{8 {Ag}^{+} + {BH}_{4}^{-} + 3 {H}_{2} O ↔ {Ag}^{0} + {B ( OH )}_{3} + 7 {H}^{+}}\end{matrix}$$

vi) The NaBH₄ solution is deposited drop by drop on the dispersion; and
It is agitated strongly, filtered, washed with distilled water and, finally, dried in a heater at 60° C.
vi) The nanocomposite powder was thus obtained, where the Ag nanoparticles were less than 15 nm in size.

### EXAMPLE 2

### Biocide Activity and Leaching of the Nanocomposite Powder

Bactericidal tests were conducted to investigate the effects of the samples containing silver on different organisms: Escherichia coli JM 110 (Gram-negative bacteria), Micrococcus luteus (Gram-positive bacteria) and Issatchenkia orientalis (yeast). The microorganisms were sown in a Luria-Bertani (LB) solid medium on Petri dishes (containing: 1% tryptone, 0.5% yeast extract, 1% ClNa, 1.5% agar) for E. coli JM110 and M. luteus or yeast extract dextrose (YEPD) (containing: 1% yeast extract, 2% peptone, 2% glucose). The dishes were incubated for 24 hours at 37° C. Next, isolated colonies of the aforementioned dishes of each microorganism were inoculated into 5 mL of LB (bacteria) or YEPD (yeast) and cultivated at 37° C. for 5 hours to obtain the pre-cultures. Aqueous suspensions of 200 mg/ml (weight/weight) of preparations M1 and M2 containing 1% silver were simultaneously prepared. Finally, 10 μL of each of the pre-cultures of microorganisms were inoculated into 1 mL of LB or YEPD, depending on the microorganism. Next, 150 μL of the HA/nAg samples (M1 and M2) were added to the cultures, resulting in a final concentration of 0.13% by weight of Ag. Likewise, samples without silver were prepared for control purposes, consisting of a mixture of water and the corresponding nutrient. The cultures were incubated at 37° C. with agitation and aliquots were taken of the different cultures for viable counts after performing serialised dilutions of each.

Biocide Test Performed with Micrococcus luteus

An aqueous suspension (9% by weight of solids) was prepared with the HA powder obtained using Method 1 (AgNO₃ was used as a silver precursor and the silver content of the final compound, HA-Ag, was 1% by weight (referenced to the HA solid content)). The test performed with Micrococcus luteus showed a title of <1.0·10⁴ after 24 hours, while the control is 3.0·10⁹.

After 72 hours, the concentration of calcium leached into the culture medium was found to be within the range of 15-30 ppm. The concentration of silver was <5 ppm. Parallel thereto, the same starting concentration of silver as of commercial nanostructured Silver Vitelinate (Argenol, with a particle size of less than 20 nm) was inoculated therein, whereupon it was observed that approximately 1,300 ppm of silver was leached.

Biocide Test Performed with Escherichia coli

An aqueous suspension (9% by weight of solids) was prepared with the HA powder obtained using Method 1 (AgNO₃ was used as a silver precursor and the silver content in the final compound, HA-Ag, was 1% by weight (referenced to the HA solid content)). The test performed with Escherichia coli JM 110 showed a title of <1.0·10⁴ after 24 hours, while the control is 1.4·10¹¹.

After 72 hours, the concentration of calcium leached into the culture medium was found to be within the range of 15-30 ppm. The concentration of silver was <5 ppm. Parallel thereto, the same starting concentration of commercial nanostructured Silver Vitelinate (Argenol, with a particle size of less than 20 nm) was inoculated therein, whereupon it was observed that approximately 900 ppm of silver was leached.

Biocide Test Performed with Issatchenkia Orientalis

An aqueous suspension (9% by weight of solids) was prepared with the HA powder obtained using Method 2 (AgNO₃ was used as a silver precursor) and the silver content in the final compound, HA-Ag, was 1% by weight (referenced to the HA solid content)). The bactericidal test performed with Issatchenkia orientalis showed a title of 1.0·10⁴ after 24 hours, while the control is 1.2·10¹¹.

After 72 hours, the concentration of calcium leached into the culture was found to be within the range of 15-30 ppm. The concentration of silver was <5 ppm. Parallel thereto, the same starting concentration of commercial nanostructured Silver Vitelinate (Argenol, with a particle size of less than 20 nm) was inoculated therein, whereupon it was observed that approximately 800 ppm of silver was leached.

Biocide Test Performed with Micrococcus luteus

An aqueous suspension (9% by weight of solids) was prepared with the HA powder obtained using Method 2 (AgNO₃ was used as a silver precursor) and the silver content in the final compound, HA-Ag, was 1% by weight (referenced to the HA solid content)). The bactericidal test performed with Micrococcus luteus showed a title of 4.0·10⁴ of 24 hours, while the control is 3.0·10⁹.

After 72 hours, the concentration of calcium leached into the culture was found to be within the range of 15-30 ppm. The concentration of silver was <5 ppm. Parallel thereto, the same starting concentration of commercial nanostructured Silver Vitelinate (Argenol, with a particle size of less than 20 nm) was inoculated therein, whereupon it was observed that approximately 900 ppm of silver was leached.

Biocide Test Performed with Escherichia coli JM 110

An aqueous suspension (9% by weight of solids) was prepared with the HA powder obtained using Method 2 (AgNO₃ was used as a silver precursor) and the silver content in the final compound, HA-Ag, was 1% by weight (referenced to the HA solid content)). The bactericidal test performed with Escherichia coli JM 110 showed a title of <1.0·10⁴ after 24 hours, while the control is 1.4·10¹¹.

After 72 hours, the concentration of calcium leached into the culture was found to be within the range of 15-30 ppm. The concentration of silver was <5 ppm. Parallel thereto, the same starting concentration of commercial nanostructured Silver Vitelinate (Argenol, with a particle size of less than 20 nm) was inoculated therein, whereupon it was observed that approximately 1,300 ppm of silver was leached.

1-9. (canceled)

10. A nanocomposite powder comprising calcium phosphate having a particle size of less than about 150 nm and Ag nanoparticles on the surface of the calcium phosphate.

11. The nanocomposite powder according to claim 10, wherein the Ag nanoparticles have a particle size less than about 50 nm.

12. The nanocomposite powder according to claim 10, wherein the calcium phosphate is selected from the group of hydroxyapatite, α-TCP, β-TCP and combinations thereof.

13. The nanocomposite powder according to claim 12, wherein the calcium phosphate is hydroxyapatite.

14. The nanocomposite powder according to claim 10, wherein the Ag nanoparticles comprise between about 0.01% and about 8% by weight of the nanocomposite powder.

15. The nanocomposite powder according to claim 14, wherein the Ag nanoparticles comprise about 1% by weight of the nanocomposite powder.

16. A method of forming a nanocomposite powder comprising:
a) preparing a nanometric calcium phosphate by a sol-gel processing route; and
b) depositing silver nanoparticles on the calcium phosphate surface.

17. The method according to claim 16, wherein the nanometric calcium phosphate has a particle size of less than about 150 nm.

18. The method according to claim 16, wherein the Ag nanoparticles have a particle size less than about 50 nm.

19. The method according to claim 16, wherein the preparing step comprises:
1) preparing an aqueous solution with an amount of triethyl phosphite and an amount of calcium nitrate;
2) adding a phosphorus solution drop by drop to the calcium solution while agitating strongly, maintaining a controlled temperature and pH forming a colloidal suspension;
3) agitating the colloidal suspension and subsequently ageing at ambient temperature to form a gel; and
4) drying of the gel in a vacuum heater until fully eliminating the solvent and calcination at a temperature between about 500° C. and about 1,000° C. to obtain the nanometric calcium phosphate.

20. The method according to claim 16, wherein the nanometric calcium phosphate is hydroxyapatite.

21. The method according to claim 20, wherein the amount of triethyl phosphite and the amount of calcium nitrate are present in a calcium nitrate/triethyl phosphite molar ratio of about 1.67.

22. The method according to claim 16, wherein the depositing step comprises:
i) preparing an aqueous suspension with the nanometric calcium phosphate, adjusting the pH to 5 and adding an anionic surfactant at low concentration;
ii) adding, in the absence of light, an aqueous solution of a silver salt precursor having a concentration of elemental silver between about 0.01% and about 8% by weight;
iii) Agitating strongly the suspension, adjusting the pH to 9, in such a manner that Ag⁺ cations precipitate as oxide (Ag₂O);
iv) filtering, washing with distilled water and drying the resulting powder; and
v) reducing in a H₂/Ar atmosphere within a temperature range of between about 150° C. and about 500° C.

23. The method according to claim 22, wherein the temperature in the reducing step is about 350° C.

24. The method according to claim 16, wherein the depositing step comprises:
i) preparing an aqueous suspension with the nanometric calcium phosphate and adding an anionic surfactant at low concentration;
ii) adjusting the pH to 7 using an aqueous NaOH 0.1 N solution;
iii) applying an ultrasound probe for 1-10 minutes and completing homogenisation and disintegration in a ball mill;
iv) addition drop by drop of an amount of the silver precursor solution, AgNO₃, necessary to obtain an Ag⁰ concentration in the final product between about 0.01% and about 8% by weight;
v) Agitating strongly for 10 minutes;
vi) reducing the silver in situ; and
vii) filtering, washing with distilled water and drying in a heater at 60° C.

25. The method according to claim 24, wherein the reducing step comprises adding NaBH₄ drop by drop to the dispersion while continuing to agitate strongly.

26. A composition comprising nanocomposite powder according to claim 10.

27. The composition according to claim 26, used as a bactericide.

28. The composition according to claim 26, used as a fungicide.

29. The composition according to claim 26, used as a disinfectant for surgical implants, public facilities, food, dentistry, paints, clothes and packaging.
